(19) United States
(12) Patent Application Publication
(10) Pub. No.: US 2003/0182563 A1
(43) Pub. Date: Sep. 25, 2003

(54) Method and apparatus for software license verification

(76) Inventors: James C. Liu, Sunnyvale, CA (US); Vicki L. Abe, Rolling Hills Estates, CA (US)

Correspondence Address: ROSENTHAL & OSHA L.L.P. / SUN, 1221 MCKINNEY, SUITE 2800, HOUSTON, TX, 77010, US

(21) Appl. No.: 10/105,135

(22) Filed: Mar. 22, 2002

(51) Int. Cl. G06F 11/30; G06F 9/44

(52) U.S. Cl. 713/191; 717/168

(57) ABSTRACT

A method for verification of a license agreement of a licensed software application includes selecting a package of the licensed software application, archiving the package to generate an archived package if the package does not require special installation handling, encrypting the archived package to generate an encrypted package, transferring the encrypted package onto a user computer, prompting a user of the user computer to input a verification response for the license agreement, decrypting the encrypted package to generate an archived install package if the verification response equals a predetermined value, un-archiving the archived install package to generate an un-archived install package, and installing the un-archived install package on the user computer.

### BACKGROUND OF THE INVENTION

Software licenses are often used by software vendors in order to prevent software piracy or to shield software vendors from legal liability in connection with the use of software supplied by the software vendors. Installing a licensed software application often requires acceptance of provisions by an end-user of an end-user contractual agreement. During an installation process of a licensed software application on a standard computer system, the end-user typically is required to accept the end-user contractual agreement by giving a verification response. Accepting the end-user contractual agreement verifies the software license.

For example, the end-user may be presented with a visual prompt and required to check a box labeled “Accept,” using an input means of the standard computer system, such as a mouse or keyboard. Failure to provide a satisfactory verification response halts the software installation process. End-user contractual agreements are typically legal documents, in that providing the verification response indicates that the user abides by and accepts the provisions of the end-user contractual agreement.

Licensed software may include other measures in order to prevent piracy of software, such as requiring the end-user to enter a registration key in order to complete the software installation process. Another technique used to protect licensed software includes the use of license files and license keys, which employ cryptographic techniques and unique host identifications and are often used to tie operation of licensed software to a particular computer or computer network. License keys are sometimes used with runtime verification mechanisms that are part of software licensing management systems. Such software licensing management systems are often useful for certain types of software, such as software with a high revenue potential.

However, such measures as registration keys and license keys may be inappropriate for certain other types of software, such as demo software, provided for evaluation purposes. Demo software is often intended to be distributed as widely as possible, thereby garnering as much exposure to potential buyers or end-users as possible. Although wide distribution of demo software may well be desirable, and such demo software may even be provided freely to users, legal liability considerations may still play a role in software licensing considerations for demo software or other types of software for which techniques such as license keys may be inappropriate. Thus, considerations such as legal liability often mandate that potential users of demo software be required to indicate acceptance of terms of an end-user contractual agreement included as part of a software license.

As part of a typical process of transferring licensed software to end users, the files that make up the licensed software application are aggregated into packages. The packages are bundled into an archive in order to facilitate shipping on storage media (such as CD ROM) or to facilitate electronic transmission. Other components, such as a software license and an install manager program, may be included in the archive. The archived packages may be compressed. Various types of archive files are in common usage, such as “.tar.gz,” “.zip,” or, for shell archives, “.shar” files.

The archived packages may be transferred to an end-user computer through various means, such as downloading through a network, e.g., the Internet, or by purchase of a CD ROM at a store, and loading the archived packages onto the end-user computer through a CD ROM drive.

Once the archived packages have been transferred to the end-user computer, an unbundling process of the archived packages is initiated. The archived packages are typically decompressed and unbundled using an archival utility to produce un-archived packages, which are placed in a directory for a subsequent installation process. Installation of the licensed software represented by the un-archived packages is performed by installing the un-archived packages.

In many instances, for certain types of licensed software, techniques such as license keys, license files, etc., are inappropriate. However, in such instances, often because of legal liability concerns, acceptance of an end-user contractual agreement by the end-user is desirable, and so, therefore, the end-user may be presented with a visual prompt for an end-user contractual agreement while unbundling the archived packages. In such instances, unbundling cannot proceed until the end-user provides a satisfactory verification response and, thus, agrees to accept the end user contractual agreement, and verifies the license of the licensed software. Thus, a software vendor providing the archived packages is provided a measure of legal liability with respect to the licensed software.

However, a possibility exists, given the scenario outlined above, that the end-user contractual agreement may be thwarted, and thus software license verification fails. For example, if a first end-user is presented with a visual prompt for an end-user contractual agreement while unbundling the archived packages, the first end-user may provide a satisfactory verification response and agree to accept the provisions of the end user contractual agreement, thus allowing unbundling. However, the first end-user may place the un-archived packages onto a storage media, e.g., a floppy disk, and give the floppy disk to a second end-user. The second end-user may then install the un-archived packages elsewhere, and because the visual prompt is displayed during unbundling, and not during installation, the second end-user is not forced to accept the end-user contractual agreement.

The process of bundling the packages that represent the licensed software, transferring the archived packages to an end-user computer, unbundling the archived packages, and installing the un-archived packages may be implemented on a network system, such as shown in FIG. 1. A distribution computer (10) is connected to an end-user computer (12) by a data transfer device (14). Bundling of the packages into archived packages occurs on the distribution computer (10). Unbundling of the archived packages and installing of the un-archived packages occurs on the end-user computer (12). The data transfer device (14) transfers the archived packages from the distribution computer (10) to the end-user computer (12). The data transfer device (14) may be a computer network, such as the Internet, or some other means or combination of means.

For example, an end-user may purchase a floppy disk with the archived packages, and load the contents of the floppy disk onto the end-user computer (12). Both the distribution computer (10) and the end-user computer (12) include a processor (16, 18), an associated memory element (20, 22), a storage device (24, 26), and numerous other elements and functionalities typical of today's computers (not shown). Both the distribution computer (10) and the end-user computer (12) may also include input means, such as a keyboard (28, 30) and a mouse (32, 34), and a display device, such as a monitor (36, 38).

### SUMMARY OF INVENTION

In general, in one aspect, the invention relates to a method for verification of a license agreement of a licensed software application. The method comprises selecting a package of the licensed software application, archiving the package to generate an archived package if the package does not require special installation handling, encrypting the archived package to generate an encrypted package, transferring the encrypted package onto a user computer, prompting a user of the user computer to input a verification response for the license agreement, decrypting the encrypted package to generate an archived install package if the verification response equals a predetermined value, un-archiving the archived install package to generate an un-archived install package, and installing the un-archived install package on the user computer.

In general, in one aspect, the invention relates to a method for verification of a license agreement of a licensed software application. The method comprises selecting a package of the licensed software application, archiving the package to generate an archived package if the package does not require special installation handling, encrypting the archived package to generate an encrypted package, transferring the encrypted package onto a user computer, transferring a custom install package onto the user computer, transferring an installer onto the user computer, initiating an installation process of the package on the user computer using the installer, prompting a user of the user computer to input a verification response for the license agreement, decrypting the encrypted package to generate an archived install package if the verification response equals a predetermined value, terminating the installation process if the verification response does not equal the predetermined value, un-archiving the archived install package to generate an un-archived install package, and installing the un-archived install package on the user computer.

In general, in one aspect, the invention relates to a network computer system for verification of a license agreement of a licensed software application. The network computer system comprises an end-user computer, an encrypted package of the licensed software application, an installer comprising software to decrypt the encrypted package and install the encrypted package on the end-user computer if the license agreement is verified, and a data transfer device transferring the installer and the encrypted package onto the end-user computer, the encrypted package comprising a package not requiring special installation handling.

In general, in one aspect, the invention relates to an apparatus for verification of a license agreement of a licensed software application. The apparatus comprises means for selecting a package of the licensed software application, means for archiving the package to generate an archived package if the package does not require special installation handling, means for encrypting the archived package to generate an encrypted package, means for transferring the encrypted package onto a user computer, means for prompting a user of the user computer to input a verification response for the license agreement, means for decrypting the encrypted package to generate an archived install package if the verification response equals a predetermined value, means for un-archiving the archived install package to generate an un-archived install package, and means for installing the un-archived install package on the user computer.

Other aspects and advantages of the invention will be apparent from the following description and the appended claims.

### BRIEF DESCRIPTION OF DRAWINGS

FIG. 1 shows a network system used in distributing software.

FIG. 2 shows a first portion of a sequence of operations for enhancing software license verification.

FIG. 3 shows a second portion of a sequence of operations for enhancing software license verification.

FIG. 4 shows an end-user contractual agreement screen.

### DETAILED DESCRIPTION

Specific embodiments of the invention will now be described in detail with reference to the accompanying figures. Like elements in the various figures are denoted by like reference numerals for consistency.

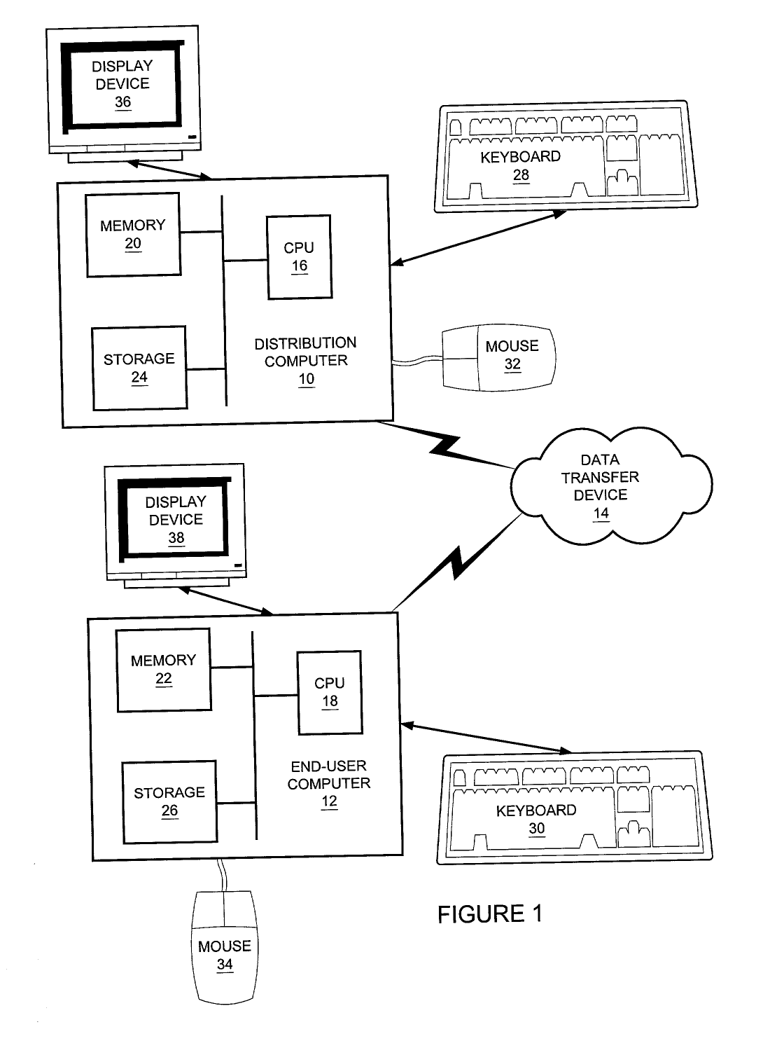

The invention described herein may involve any computer regardless of the platform being used. In accordance with one or more embodiments, the invention is implemented on the network system shown in FIG. 1. The invention involves a method and apparatus for enhancing enforcement of software license verification by encrypting software distributed to end-users, and decrypting and installing the software on an end-user computer only if the end-user agrees to terms of a software license agreement. An installer and standard installation functionality is bundled with the software.

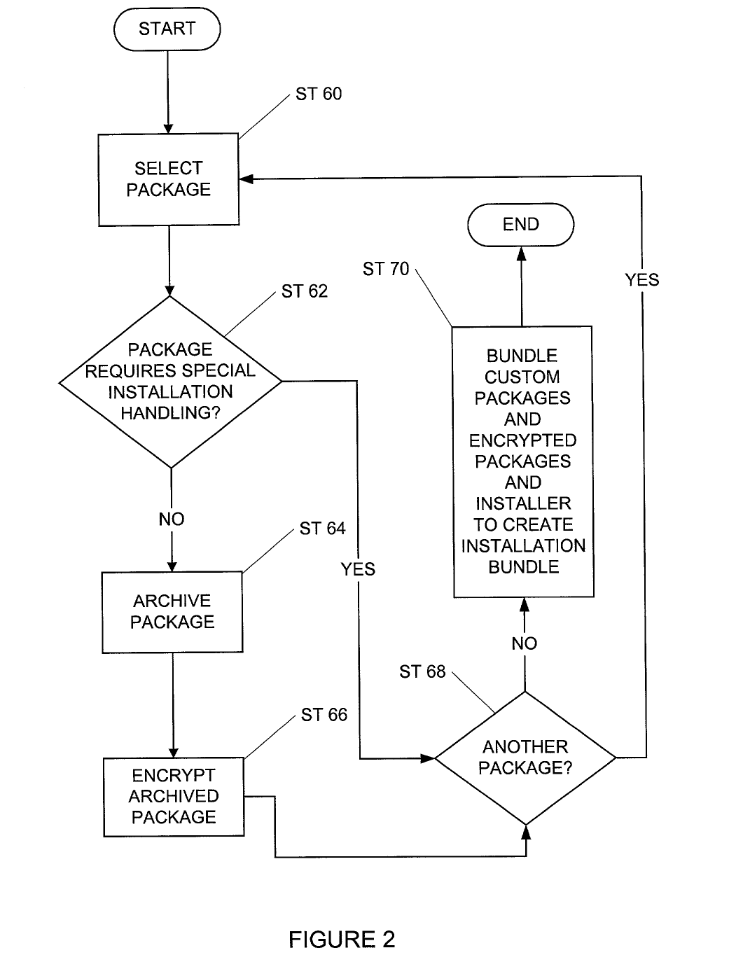

A sequence of operations is shown in FIG. 2 for enhancing software license verification during a process of installing a licensed software application. A package representing the licensed software application is selected (Step 60). The package, in accordance with one or more embodiments of the invention, is one or more binary files of the licensed software application to be distributed to, and installed on, an end-user computer. A determination is made as to whether the package requires special installation handling (Step 62). For example, certain packages (“custom packages”) require partial installation and configuration during installation on the end-user computer.

If the package does not require special installation handling, the package is archived (Step 64), thus generating an archived package. Various archival methods may be employed. For example, the “.zip” archive format is used in a particular embodiment of the invention because the .zip format compresses data tightly to conserve storage space.

The archived package is encrypted (Step 66), thus generating an encrypted package. In accordance with one or more embodiments of the invention, a symmetric encryption scheme is used to encrypt the archived package. For example, a Berkeley crypt( ) engine, based on a single-rotor Enigma machine, may be used to generate the encrypted package.

A determination is made as to whether another package exists to be selected (Step 68). If another package exists to be selected, Step 60 is performed. Otherwise, any custom packages and any encrypted packages to be distributed to the end-user computer are bundled to create an installation bundle (Step 70). In accordance with one or more embodiments of the invention, bundling may entail compression, storage, and/or aggregation of the custom packages and encrypted packages on a storage medium. An installer is included as part of the installation bundle. The installer includes decryption and installation functionality, functionality to prompt the end-user to accept terms of an end-user contractual agreement, and perform any needed post-install cleanup.

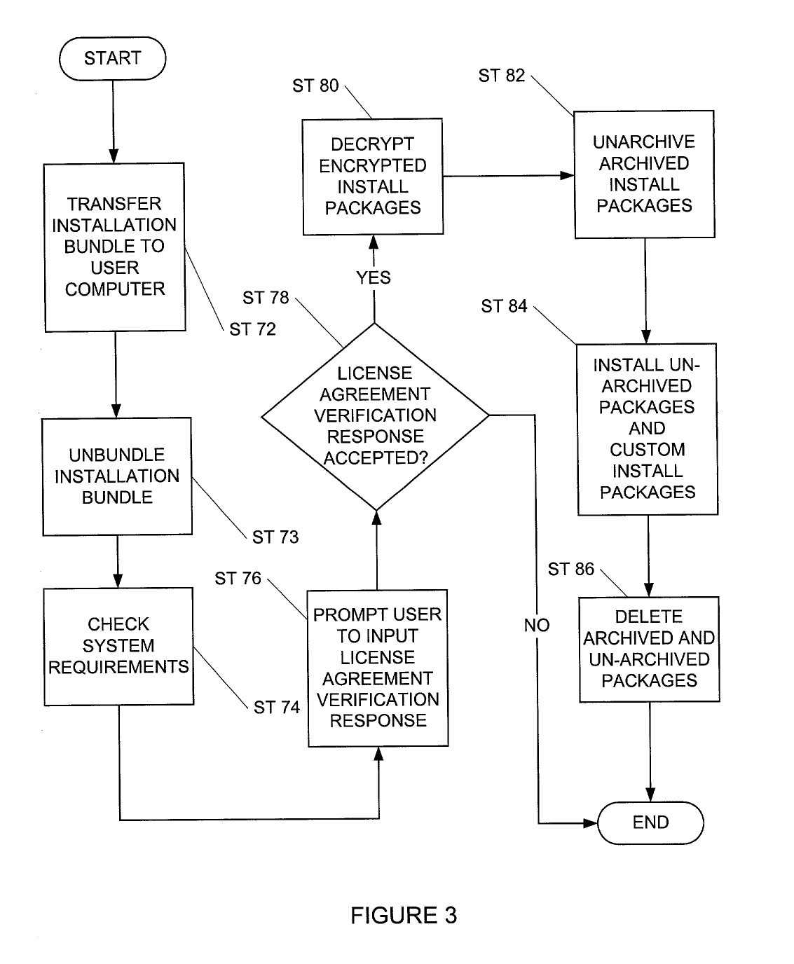

The sequence of operations for enhancing software license verification continues on FIG. 3. The installation bundle is transferred via a data transfer device (Step 72). The data transfer device may be a computer network, such as the Internet, or some other means or combination of means. For example, the end-user may purchase a floppy disk containing the installation bundle and load the floppy disk onto the end-user computer via a floppy drive.

Once the installation bundle is transferred to the end-user computer, the installation bundle is unbundled (Step 73). In accordance with one or more embodiments of the invention, unbundling may involve decompressing the installation bundle. Alternatively, unbundling may involve reading a storage medium on which the installation bundle is stored. As a result of unbundling, encrypted install packages and custom install packages are made accessible to the end-user computer. Encrypted install packages are a product of bundling and unbundling the encrypted packages. Custom install packages are a product of bundling and unbundling the custom packages.

As a result of unbundling, the installer is executed on the end-user computer. The installer initiates a process of installing the licensed software application on the end-user computer.

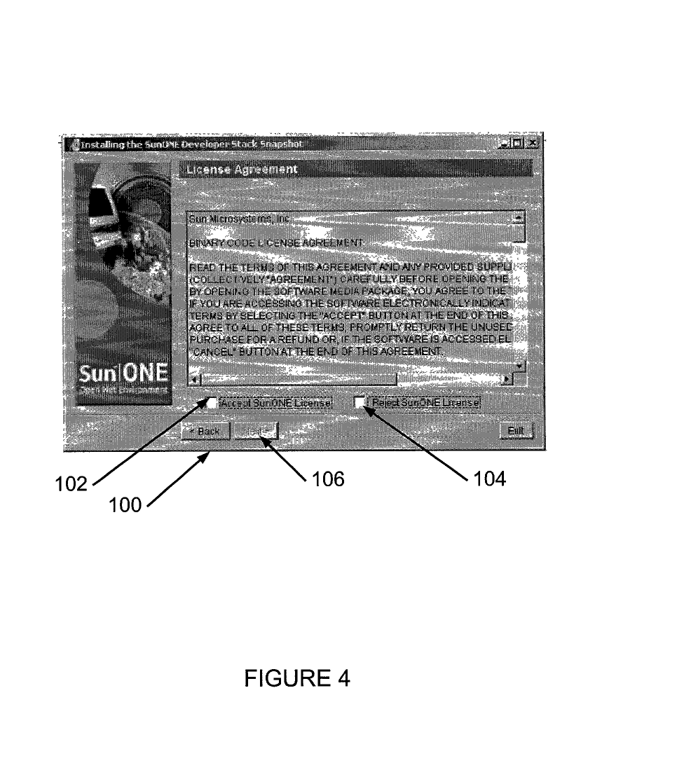

A check is made of system requirements for the end-user computer (Step 74). The end-user is then prompted to input a license agreement verification response by displaying an end-user contractual agreement screen as shown in FIG. 4 (Step 76). FIG. 4 shows an example of one embodiment of the invention for a SunOne Developer Stack™ end-user contractual agreement screen. The end-user contractual agreement screen (100) has an “Accept” check box (102), a “Reject” check box (104), and a “Next” button (106) that is “grayed-out” until the “Accept” check box (102) is checked.

Referring to FIG. 3, a determination is made as to whether the end-user has accepted the end-user contractual agreement (Step 78). If the end-user has not checked the “Accept” check box (102), as shown in FIG. 4, the process of installing the licensed software application on the end-user computer terminates.

Otherwise, if the end-user has checked the “Accept” check box (102), as shown in FIG. 4, the encrypted install packages are decrypted (Step 80). The encrypted install packages are decrypted using a symmetric key included in the installation bundle and accessible to the installer. As a result of decrypting the encrypted install packages, archived install packages are generated.

The archived install packages are un-archived to generate un-archived install packages (Step 82). The archived install packages are un-archived using an archival utility that may be included in the installation bundle or available on the end-user computer.

The un-archived install packages and the custom install packages are installed on the end-user computer (Step 84). Those skilled in the art will realize that the sequence of operations as shown above may differ in accordance with one or more embodiments of the invention. For example, installation of certain of the custom install packages occurs before, or is interleaved with, installation of the un-archived install packages.

The installer deletes any archived install packages and any un-archived install packages that are stored on secondary storage (Step 86), completing installation of the licensed software application.

In order to impede unauthorized distribution of the archived install packages and the un-archived install packages, in accordance with one or more embodiments of the invention, the installer may handle the archived install packages and the un-archived install packages entirely in random access memory. As a result, the archived install packages and the un-archived install packages are not stored in temporary files. In order to handle the packages entirely in random access memory, the installer may use industry-standard techniques, such as establishing inter-process communication paths (e.g., pipes), through which the archived install packages and the un-archived install packages are routed. The installer may establish inter-process communication paths through such means as Java™ application programming interface (API) calls and/or and abstract input/output streams. Routing the archived install packages and the un-archived install packages using inter-process communication paths involves sending the archived install packages and/or the un-archived install packages from a first operating system process to a second operating system process through an inter-process communication path. Thus, the archived install packages and the un-archived install packages, which are not encrypted, and otherwise would be vulnerable to copying and distribution by the end-user, are not stored on the end-user computer secondary storage (e.g., a hard drive). Alternatively, the archived install packages and the un-archived install packages may be stored in temporary files on the hard drive on the end-user computer, and subsequently deleted as mentioned in Step 86, if suitable for a particular embodiment of the invention.

Advantages of the invention may include one or more of the following. The difficulty level associated with thwarting an end-user contractual agreement is increased, thus enhancing software license verification. The difficulty level associated with thwarting the end-user contractual agreement is increased through encryption packages that are distributed to end-users. Unencrypted files produced during installation are either deleted after installation or handled entirely in random access memory, thereby increasing the difficulty level associated with thwarting the end-user contractual agreement. Those skilled in the art will appreciate that the invention may have additional advantages and features not detailed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for verification of a license agreement of a licensed software application, comprising:
selecting a package of the licensed software application;
archiving the package to generate an archived package if the package does not require special installation handling;
encrypting the archived package to generate an encrypted package;
transferring the encrypted package onto a user computer;
prompting a user of the user computer to input a verification response for the license agreement;
decrypting the encrypted package to generate an archived install package if the verification response equals a predetermined value;
un-archiving the archived install package to generate an un-archived install package; and
installing the un-archived install package on the user computer.

2. The method of claim 1, archiving the package comprising producing a zip archive file.

3. The method of claim 1, encrypting the archived package comprising symmetric key encryption.

4. The method of claim 1, decrypting the encrypted package comprising symmetric key encryption.

5. The method of claim 1, further comprising:
transferring an installer onto the user computer;
initiating an installation process of the package on the user computer using the installer; and
terminating the installation process if the verification response does not equal the predetermined value.

6. The method of claim 5, further comprising:
sending the archived install package from a first operating system process to a second operating system process via an inter-process communication path; and
sending the un-archived install package from a first operating system process to a second operating system process via an inter-process communication path.

7. The method of claim 5, further comprising:
storing the archived install package on a storage medium of the user computer;
storing the archived install package on a storage medium of the user computer;
deleting the un-archived install package from the storage medium; and
deleting the archived install package from the storage medium.

8. The method of claim 1, further comprising:
transferring a custom install package onto the user computer.

9. The method of claim 8, wherein the custom install package is not compressed.

10. The method of claim 8, further comprising:
installing the custom install package onto the user computer.

11. A method for verification of a license agreement of a licensed software application, comprising:
selecting a package of the licensed software application;
archiving the package to generate an archived package if the package does not require special installation handling;
encrypting the archived package to generate an encrypted package;
transferring the encrypted package onto a user computer;
transferring a custom install package onto the user computer;
transferring an installer onto the user computer;
initiating an installation process of the package on the user computer using the installer;
prompting a user of the user computer to input a verification response for the license agreement;
decrypting the encrypted package to generate an archived install package if the verification response equals a predetermined value;
terminating the installation process if the verification response does not equal the predetermined value;
un-archiving the archived install package to generate an un-archived install package; and
installing the un-archived install package on the user computer.

12. A network computer system for verification of a license agreement of a licensed software application, comprising:
an end-user computer;
an encrypted package of the licensed software application;
an installer comprising software to decrypt the encrypted package and install the encrypted package on the end-user computer if the license agreement is verified;
a data transfer device transferring the installer and the encrypted package onto the end-user computer; and
the encrypted package comprising a package not requiring special installation handling.

13. The network computer system of claim 12, the encrypted package comprising a package not requiring special installation handling.

14. The network computer system of claim 12, further comprising:
a distribution computer initially holding the installer and the encrypted package.

15. The network computer system of claim 14, further comprising a custom package transferred from the distribution computer to the end-user computer via the data transfer device.

16. The network computer system of claim 15, the custom package comprising a package requiring special installation handling.

17. The network computer system of claim 16, the installer further comprising software to install the custom package on the end-user computer if the license agreement is verified.

18. The network computer system of claim 12, further comprising:
a symmetric key used to decrypt the encrypted package.

19. The network computer system of claim 12, verifying the license agreement comprising an end-user accepting terms of an end-user contractual agreement.

20. The network computer system of claim 19, further comprising:
a screen displaying the end-user contractual agreement.

21. The network computer system of claim 19, the end-user accepting terms of the end-user contractual agreement comprising the end-user using an input device of the end-user computer to give a verification response.

22. An apparatus for verification of a license agreement of a licensed software application, comprising:
means for selecting a package of the licensed software application;
means for archiving the package to generate an archived package if the package does not require special installation handling;
means for encrypting the archived package to generate an encrypted package;
means for transferring the encrypted package onto a user computer;
means for prompting a user of the user computer to input a verification response for the license agreement;
means for decrypting the encrypted package to generate an archived install package if the verification response equals a predetermined value;
means for un-archiving the archived install package to generate an un-archived install package; and
means for installing the un-archived install package on the user computer.
